(19) United States
(12) Patent Application Publication
(10) Pub. No.: US 2025/0315644 A1
(43) Pub. Date: Oct. 9, 2025

(54) SUSTAINABLE MEMORY RECALL FOR NEURAL NETWORKS

(71) Applicant: INTERNATIONAL BUSINESS MACHINES CORPORATION, ARMONK, NY (US)

(72) Inventors: JOHN S. WERNER, FISHKILL, NY (US); ANDREW C. M. HICKS, HIGHLAND, NY (US)

(21) Appl. No.: 18/625,323

(22) Filed: Apr. 3, 2024

(51) Int. Cl. G06N 3/04

(52) U.S. Cl. CPC G06N 3/04

(57) ABSTRACT

Sustainable memory recall for neural networks, including: receiving one or more inputs for a neural network; monitoring a power utilization metric during processing of the one or more inputs by the neural network; determining, responsive to the power utilization metric exceeding a first threshold, whether an output confidence at a pre-output layer of the neural network exceeds a second threshold; and storing, responsive to the output confidence exceeding the second threshold, an entry in a memory lookup table comprising an output of the neural network.

### BACKGROUND

The present disclosure relates to methods, apparatus, and products for sustainable memory recall for neural networks. As the complexity of neural networks grows, the amount of power consumed in both training and using those neural networks may increase significantly. Moreover, where neural networks are repeatedly used to process identical or similar inputs, significant amounts of power and processing resources may be used to effectively repeat computationally- and power-intensive operations. Although processing of neural networks may be constrained in order to conform with sustainability or power utilization goals, this may negatively impact the confidence and accuracy of the outputs from those neural networks. Accordingly, it may be beneficial to address power utilization in executing neural networks while maintaining the confidence and accuracy of the neural network outputs.

### SUMMARY

According to embodiments of the present disclosure, various methods, apparatus and products for sustainable memory recall for neural networks are described herein. In some aspects, sustainable memory recall for neural networks includes receiving one or more inputs for a neural network; monitoring a power utilization metric during processing of the one or more inputs by the neural network; determining, responsive to the power utilization metric exceeding a first threshold, whether an output confidence at a pre-output layer of the neural network exceeds a second threshold; and storing, responsive to the output confidence exceeding the second threshold, an entry in a memory lookup table comprising an output of the neural network. This provides the advantage of storing, for later lookup, an entry in a memory lookup table for neural network inputs that resulted in power utilization exceeding some threshold. In some aspects, an apparatus may include a processing device; and memory operatively coupled to the processing device, wherein the memory stores computer program instructions that, when executed, cause the processing device to perform this method. In some aspects, a computer program product comprising a computer readable storage medium may store computer program instructions that, when executed, perform this method.

In some embodiments, this method may also include determining whether to store the entry in the memory lookup table based on a comparison between the output confidence at the pre-output layer of the neural network and another output confidence at an output layer of the neural network. This provides the advantage of only storing entries in the memory lookup table where the output confidence gain between the pre-output layer and the output layer falls below a threshold, allowing for full processing of inputs by the neural network where there is a significant confidence gain approaching the output layer.

In some embodiments, this method may also include: receiving another one or more inputs for the neural network; determining, during processing of the other one or more inputs by the neural network, whether an entry matching an activation map signature for processing the other one or more inputs is stored in the memory lookup table; and responsive to the entry being stored in the memory lookup table, providing a stored output of the entry instead of processing the other one or more inputs through all layers of the neural network. This provides the advantage of loading of outputs from the memory lookup table from previously created entries, preventing the full processing of previously processed neural network inputs having high power utilization and confidence, saving on processing and power consumption resources.

In some embodiments, this method may also include determining, during processing of the other one or more inputs by the neural network, that another power utilization metric exceeds a third threshold; and responsive to the other power utilization metric exceeding the third threshold, providing an intermediary output of the neural network instead of processing the other one or more inputs through all layers of the neural network. This provides the advantage of overriding the output of the neural network where power utilization exceeds a defined threshold, saving on overall power utilization.

### BRIEF DESCRIPTION OF THE DRAWINGS

FIG. 1 sets forth a diagram of an example computing environment for sustainable memory recall for neural networks in accordance with some embodiments of the present disclosure.

FIG. 2 sets forth a flowchart of an example method for sustainable memory recall for neural networks in accordance with some embodiments of the present disclosure.

FIG. 3 sets forth a flowchart of another example method for sustainable memory recall for neural networks in accordance with some embodiments of the present disclosure.

FIG. 4 sets forth a flowchart of another example method for sustainable memory recall for neural networks in accordance with some embodiments of the present disclosure.

FIG. 5 sets forth a flowchart of another example method for sustainable memory recall for neural networks in accordance with some embodiments of the present disclosure.

FIG. 6 sets forth a flowchart of another example method for sustainable memory recall for neural networks in accordance with some embodiments of the present disclosure.

### DETAILED DESCRIPTION

As the complexity of neural networks grows, the amount of power consumed in both training and using those neural networks may increase significantly. Moreover, where neural networks are repeatedly used to process identical or similar inputs, significant amounts of power and processing resources may be used to effectively repeat computationally- and power-intensive operations. Although processing of neural networks may be constrained in order to conform with sustainability or power utilization goals, this may negatively impact the confidence and accuracy of the outputs from those neural networks. Accordingly, it may be beneficial to address power utilization in executing neural networks while maintaining the confidence and accuracy of the neural network outputs.

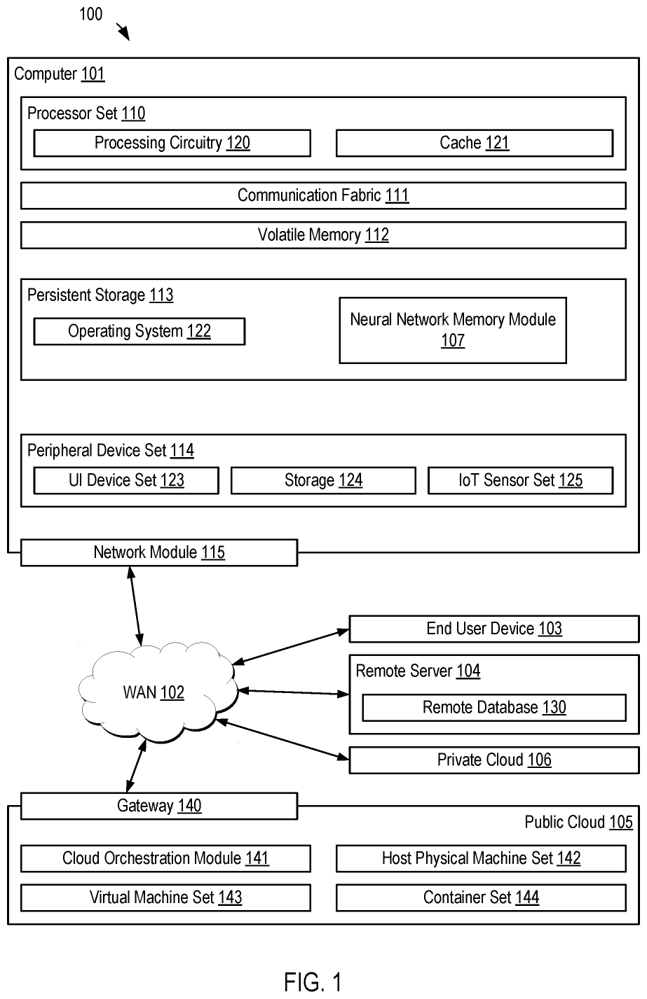

FIG. 1 sets forth an example computing environment according to aspects of the present disclosure. Computing environment 100 contains an example of an environment for the execution of at least some of the computer code involved in performing the various methods described herein, such as the neural network memory module 107. In addition to the neural network memory module 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in block 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

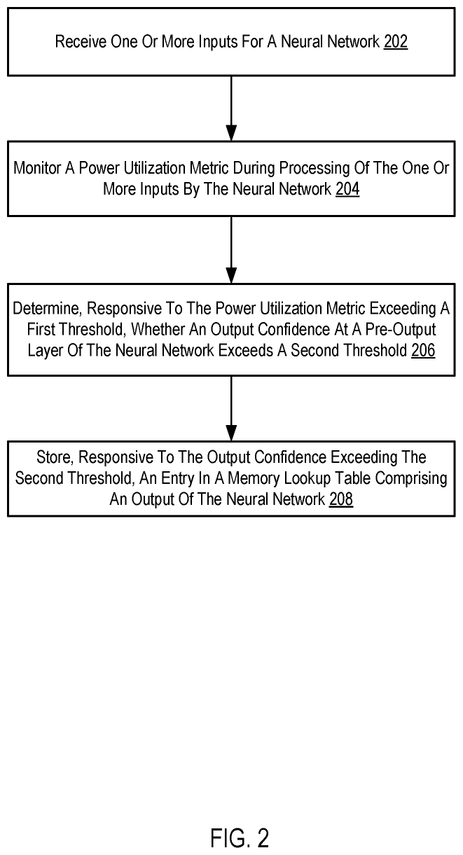

FIG. 2 sets forth a flowchart of an example method of sustainable memory recall for neural networks in accordance with some embodiments of the present disclosure. The method of FIG. 2 may be performed, for example, by the neural network memory module 107 described above. The method of FIG. 2 includes receiving 202 one or more inputs for a neural network. Although the approaches set forth herein are described in the context of a neural network, one skilled in the art will appreciate that the approaches set forth herein may be applied to any type of trained model as can be appreciated. For example, the approaches set forth herein may be applied to neural networks (e.g., feed-forward neural networks, natural language processing models, LLMs, and the like), regression models, deep learning models, support vector machines (SVMs), random forests, other generative artificial intelligence models, and/or other machine learning models as can be appreciated. The inputs are some input data to be provided to the neural network for processing to generate some output. The inputs for the neural network may be received from a variety of sources. For example, the inputs for the neural network may be generated by some process or service executed within the same device or computing environment as the neural network. As another example, the inputs may be received from a remotely disposed computing device via a network. The inputs may include any type of data as can be appreciated, such as text data, image data, video data, and the like.

The method of FIG. 2 also includes monitoring 204 a power utilization metric during processing of the one or more inputs by the neural network. In response to receiving 202 the one or more inputs for the neural network, the one or more inputs are provided as inputs to the neural network and processed in order to produce some output as described above. Readers will appreciate that, during processing of some input by a neural network, the inputs are processed by some input layer whose output may be processed through one or more hidden layers before the output of the final hidden layer is processed by an output layer that ultimately provides the output of the neural network. During the processing by each layer, neurons may be activated in a given layer.

The power utilization metric is some measurable observation reflecting an amount of power utilized or consumed while processing the inputs by the neural network. Accordingly, in some embodiments, monitoring 204 the power utilization metric may include monitoring 204 the power utilization metric over time. For example, monitoring 204 the power utilization metric may include measuring the power utilization metric at a predefined time interval, at each layer of the neural network, at each neuron activation, or in response to some other event or criteria during processing of the one or more inputs. In some embodiments, monitoring 204 the power utilization metric may include calculating or sampling the power utilization metric until and/or after the neural network has processed the inputs to provide some output. In some embodiments, monitoring 204 the power utilization metric may include calculating or sampling the power utilization metric until and/or after providing some output loaded from a memory lookup table, described in further detail below.

In some embodiments, the power utilization metric may include an amount of power consumed in processing the one or more inputs. In some embodiments, the amount of power consumed may include a measured amount of power consumed. For example, a computing device executing the one or more inputs or some other device operatively coupled to the computing device may be configured to measure amounts of power consumed at any given time or across some time duration. In some embodiments, as will be described in further detail below, the amount of power consumed may include a calculated or estimated amount of power consumed based on some other metric such as a number of activated neurons. For example, in some embodiments, a function or trained model may accept, as input, a number of activated neurons and potentially other inputs and provide, as output, an estimated amount of power consumed.

In some embodiments, the power utilization metric may include a number of activated neurons. For example, in some embodiments, a number of activated neurons (e.g., a number of neurons of the neural network activated up to the point where a measurement of activated neurons is captured) may strongly correlate with an amount of power consumed when processing the inputs by the neural network. Accordingly, in some embodiments, rather than calculate some value expressing an amount of power consumed, a number of activated neurons may instead be monitored without conversion into an amount of power consumed.

The method of FIG. 2 also includes determining 206, responsive to the power utilization metric exceeding a first threshold, whether an output confidence at a pre-output layer of the neural network exceeds a second threshold. The first threshold is a threshold level of the power utilization metric. For example, the first threshold may be based on sustainability goals related to use of the neural network, threshold levels of power consumption costs, and the like. The second threshold is a threshold level of confidence for a current level of output at any given layer of the neural network. As each layer of the neural network processes its received input (e.g., from the preceding layer or, at the input layer, the inputs themselves) the layer provides an output (e.g., to the next layer or, at the output layer, the final output) having some confidence level (e.g., the output confidence). Accordingly, the output confidence at each layer may increase over time. As referred to herein, a pre-output layer is any layer of the neural network preceding the output layer, including the input layer and any preceding hidden layers.

The method of FIG. 2 also includes storing 208, responsive to the output confidence exceeding the second threshold, an entry in a memory lookup table comprising an output of the neural network. A memory lookup table is a table, database, or other data structure that relates particular neural network inputs with outputs generated by the neural network by processing those inputs. Particularly, each entry in the memory lookup table may associate some input previously provided to the neural network, including to previous versions of the neural network, and their respective output. As described herein, a version of a neural network is an instance of that neural network trained on some corpus of training data. Thus, as the neural network is continuously or repeatedly retrained, each retraining of the neural network produces a different version of the neural network. As will be described in further detail below, where a particular input has an entry stored in the memory lookup table, the output for that particular input may be loaded from the memory lookup table and provided as output rather than fully reprocessing the particular input by the neural network.

Each entry in the memory lookup table includes some value or identifier of a particular input to the neural network and an output generated by some version of the neural network based on that particular input. In some embodiments, the value of the identifier of a particular input may include the signature for that input generated when processing the input by the neural network. Accordingly, in some embodiments, the memory lookup table may be indexed or referenced using the signature of an input. For example, in some embodiments, the signature of an input may be hashed or otherwise processed to generate an index value for accessing the memory lookup table. In some embodiments, the memory lookup table may be traversed to compare the signatures in stored entries to the signature of the current input. In some embodiments, a signature for an input may be considered a match for the signature of an entry in the memory lookup table where each point in the sequence of the signature of the input falls within some range or standard deviation of the corresponding points in the signature of the entry in the memory lookup table (e.g., a “tolerance range”). In some embodiments, the signatures in the memory lookup table may correspond to different levels or layers than the signature of the input. For example, depending on when the entry in the memory lookup table was created, the signature in the memory lookup table entry may end at a later or earlier layer than the signature of the input. In such embodiments, the signature of the memory lookup table and/or the input may be truncated such that they terminate at the same layer, after which they may be compared as described above.

In some embodiments, storing 208 the entry in the memory lookup table includes generating, for the entry and as the signature for the entry in the memory lookup table, an activation map signature. In some embodiments, the activation map signature may be based on those neurons activated in the neural network in order to generate the final output of the neural network. In some embodiments, the activation map signature may be based on those neurons activated in the neural network up to and including the pre-output layer where the output confidence exceeds the second threshold. In some embodiments, the activation map signature may include a hash or other value based on the activated neurons described above. Thus, the entry in the memory lookup table may include the activation map signature and the corresponding output value.

According to the approaches set forth above, an entry is created in the memory lookup table where both the power utilization metric exceeds the first threshold and where the output confidence exceeds the second threshold. Where the power utilization metric exceeds the first threshold, this may indicate that processing the same inputs by the neural network may result in some level of power consumption that conflicts with or negatively impacts sustainability goals. Accordingly, loading an output from a memory lookup table rather than fully processing these inputs by the neural network may result in power utilization savings. In order to create an entry in the memory lookup table such that it can be later loaded, an output confidence at some pre-output layer should be high enough (e.g., exceeding the second threshold), indicating that a high-confidence output was achieved prior to the final output layer of the neural network. Accordingly, this high-confidence output can be saved and later loaded when a matching activation map signature is found, described above. Thus, the power utilization savings are achieved for inputs that were determined to cause high power utilization but had high-confidence outputs at a pre-output layer.

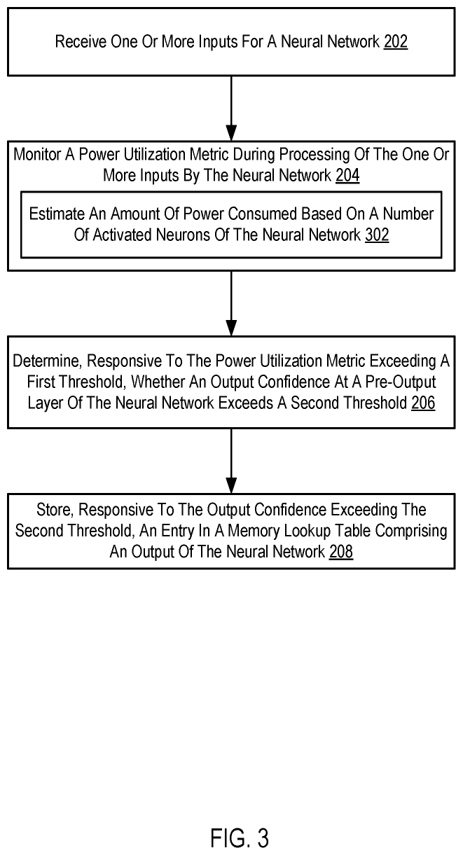

For further explanation, FIG. 3 sets forth a flowchart of an example method of sustainable memory recall for neural networks in accordance with some embodiments of the present disclosure. The method of FIG. 3 is similar to FIG. 2 in that the method of FIG. 3 also includes: receiving 202 one or more inputs for a neural network; monitoring 204 a power utilization metric during processing of the one or more inputs by the neural network; determining 206, responsive to the power utilization metric exceeding a first threshold, whether an output confidence at a pre-output layer of the neural network exceeds a second threshold; and storing 208 the entry in the memory lookup table includes generating, for the entry and as the signature for the entry in the memory lookup table, an activation map signature.

The method of FIG. 3 differs from FIG. 2 in that monitoring 204 a power utilization metric during processing of the one or more inputs by the neural network includes estimating 302 (e.g., as the power utilization metric) an amount of power consumed based on a number of activated neurons of the neural network. In some embodiments, estimating 302 an amount of power consumed based on a number of activated neurons may include providing the number of activated neurons as input to a function that provides, as output and as the power utilization metric, the estimated amount of power consumed. In some embodiments, such a function may include a trained or optimized function, including a trained multivariable function. In some embodiments, estimating 302 an amount of power consumed based on a number of activated neurons may include providing the number of activated neurons as input to a trained model that provides, as output, the estimated amount of power consumed. in some embodiments, the computations required by each activated neuron may be taken into account. Some neurons may perform more calculations or utilize more hardware resources than others. This can be estimated based on the number of and complexity of the calculations that are executed be the activated neuron.

In some embodiments, a model or function may be trained using training data indicating a number of activated neurons and a measured amount of power consumed. In some embodiments, a trained model or function may accept other data points as input in order to output the estimated amount of power consumed. Accordingly, such a trained model or function may be trained on such other data points. In some embodiments, such data points may include data describing a hardware configuration of a computing device executing the neural network, including a processor configuration, memory configuration, power supply configuration, hardware accelerator configuration, cooling configuration, and the like. In some embodiments, such data points may describe environmental factors relative to such a computing device, such as an external temperature, and the like. Such additional data points may be used to better train a function or neural network in order to estimate an amount of power consumed based on a number of activated neurons as these additional factors may affect the overall amount of measured power consumed by a computing device.

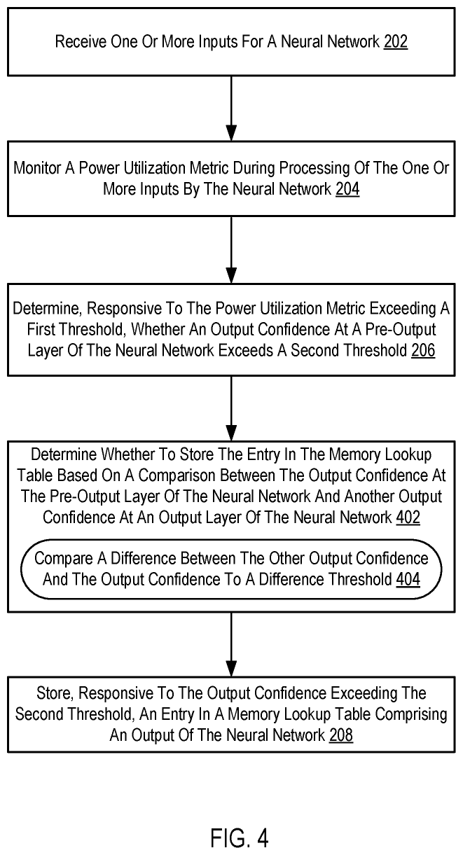

For further explanation, FIG. 4 sets forth a flowchart of an example method of sustainable memory recall for neural networks in accordance with some embodiments of the present disclosure. The method of FIG. 4 is similar to FIG. 2 in that the method of FIG. 4 also includes: receiving 202 one or more inputs for a neural network; monitoring 204 a power utilization metric during processing of the one or more inputs by the neural network; determining 206, responsive to the power utilization metric exceeding a first threshold, whether an output confidence at a pre-output layer of the neural network exceeds a second threshold; and storing 208 the entry in the memory lookup table includes generating, for the entry and as the signature for the entry in the memory lookup table, an activation map signature.

The method of FIG. 4 differs from FIG. 2 in that the method of FIG. 4 also includes determining 402 whether to store the entry in the memory lookup table based on a comparison between the output confidence at a pre-output layer of the neural network and another output confidence at an output layer of the neural network. Such a comparison reflects a degree to which the output confidence increases between the pre-output layer and the final output layer. As an example, in some embodiments, determining 402 whether to store the entry in the memory lookup table based on a comparison between the output confidence at a pre-output layer of the neural network and another output confidence at an output layer of the neural network may include comparing 404 a difference between the other output confidence and the output confidence to a difference threshold. Thus, determining 402 whether to store the entry in the memory lookup table is based on whether the difference between these confidence levels exceeds the difference threshold.

In some embodiments, where the difference exceeds the difference threshold, thereby indicating a significant increase in output confidence between the pre-output layer and the output layer, the entry will not be stored in the memory lookup table. In some embodiments, where the difference falls below the difference threshold, thereby indicating no significant increase in output confidence between the pre-output layer and the output layer, the entry will be stored in the memory lookup table. In some embodiments, instead of directly adding to the memory lookup table, a count may be maintained in a second data structure and only add to the memory lookup table if the inputs occur frequently and/or consistently fall below the difference threshold (i.e., a count threshold is exceeded wherein the inputs are then moved to the memory lookup table). This intermediate table could help to ensure that the memory lookup table does not grow too big with inputs that don't occur often and could slow down searching or increase computational power for the searching. The intermediate data structure could track the date the last input was seen or the frequency of the inputs and remove the inputs from the table if they have not been seen in a while or are not occurring frequently enough. This will keep the size of both the intermediate table and the memory lookup table down for more efficient (and less power intensive) searching to match future inputs.

Consider an example where an output confidence at a pre-output layer is seventy percent, exceeding the second threshold. Further assume a difference threshold of twenty percent. Where the output confidence at the output layer is seventy-five percent, this indicates an output confidence increase of only five percent between the pre-output layer and the output layer, falling below the difference threshold of twenty percent. Accordingly, an entry is stored 208 in the memory lookup table for later use as there is no significant confidence benefit from fully processing the input to the neural network. Where the output confidence at the output layer is ninety-two percent, this indicates an output confidence increase of twenty-two percent between the pre-output layer and the output layer, exceeding the difference threshold of twenty percent. Accordingly, no entry is stored 208 in the memory lookup table as there are significant confidence benefits in fully processing the inputs by the neural network.

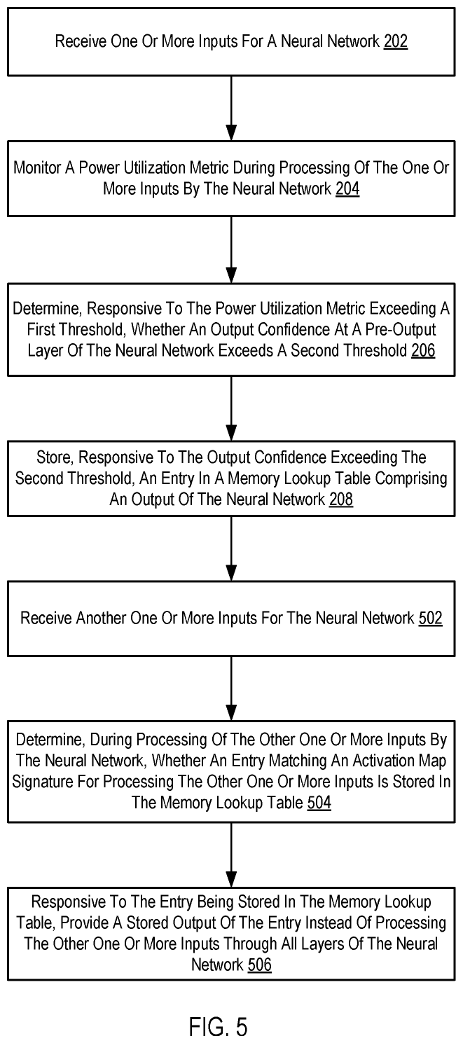

For further explanation, FIG. 5 sets forth a flowchart of an example method of sustainable memory recall for neural networks in accordance with some embodiments of the present disclosure. The method of FIG. 5 is similar to FIG. 2 in that the method of FIG. 5 also includes: receiving 202 one or more inputs for a neural network; monitoring 204 a power utilization metric during processing of the one or more inputs by the neural network; determining 206, responsive to the power utilization metric exceeding a first threshold, whether an output confidence at a pre-output layer of the neural network exceeds a second threshold; and storing 208 the entry in the memory lookup table includes generating, for the entry and as the signature for the entry in the memory lookup table, an activation map signature.

The method of FIG. 5 differs from FIG. 2 in that the method of FIG. 5 also includes receiving 502 another one or more inputs for the neural network. The one or more inputs may be received 502 according to similar approaches as are set forth above. The neural network for which the other one or more inputs are received 502 may include the neural network for which the one or more inputs are received 202, or another version of such a neural network (e.g., a retrained or otherwise updated version).

The method of FIG. 5 also includes determining 504, during processing the other one or more inputs by the neural network, whether an entry matching an activation map signature for processing the other one or more inputs is stored in the memory lookup table. In some embodiments, determining 504 whether the entry is stored in the memory lookup table may be performed at each layer of the neural network, or in response to reaching one or more defined layers for performing such a determination (e.g., a “check layer”).

In some embodiments, determining 504 whether the entry is stored in the memory lookup table may include generating an activation map signature based on those neurons currently activated at a current stage in processing the other one or more inputs (e.g., at the check layer or another current layer) and querying the memory lookup table with the generated activation map signature. Where no entry is found, processing of the other one or more inputs by the neural network continues until the one or more inputs have been fully processed or another check layer is reached. If another check layer is reached, the memory lookup table may be queried again using a regenerated activation map signature.

The method of FIG. 5 also includes responsive to the entry being stored in the memory lookup table (e.g., as determined 504 at some check layer as described above), providing 506 a stored output of the entry instead of processing the other one or more inputs through all layers of the neural network. In other words, if an entry is found in the memory lookup table, the output for the entry is provided as output for the other one or more inputs rather than completely processing these other one or more inputs by the neural network. This saves on power usage and computational resource usage that would be used in completely processing the other one or more inputs. Moreover, by using previously generated outputs, this prevents erroneous output caused by drift in retraining the neural network over time.

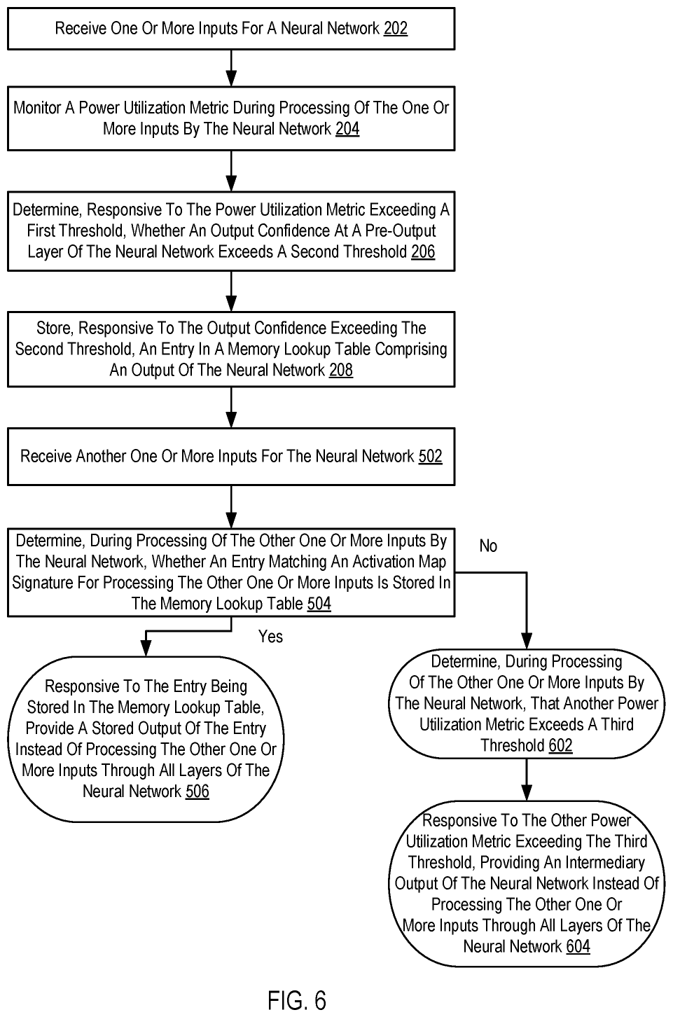

For further explanation, FIG. 6 sets forth a flowchart of an example method of sustainable memory recall for neural networks in accordance with some embodiments of the present disclosure. The method of FIG. 6 is similar to FIG. 5 in that the method of FIG. 6 also includes: receiving 202 one or more inputs for a neural network; monitoring 204 a power utilization metric during processing of the one or more inputs by the neural network; determining 206, responsive to the power utilization metric exceeding a first threshold, whether an output confidence at a pre-output layer of the neural network exceeds a second threshold; storing 208 the entry in the memory lookup table includes generating, for the entry and as the signature for the entry in the memory lookup table, an activation map signature; receiving 502 another one or more inputs for the neural network; determining 504, during processing the other one or more inputs by the neural network, whether an entry mapping an activation map signature for processing the other one or more inputs is stored in the memory lookup table; and providing 506 a stored output of the entry instead of processing the other one or more inputs through all layers of the neural network.

The method of FIG. 6 differs from FIG. 5 in that the method of FIG. 6 also includes determining 602, during processing of the other one or more inputs by the neural network, that another power utilization metric exceeds a third threshold. The other power utilization metric is a metric monitored during processing of the other one or more inputs by the neural network, which may include the same type of power utilization metric as described above, or a different power utilization metric. Here, determining 602 that the other power utilization metric exceeds the third threshold is shown as being performed in response to determining that no entry is stored in the memory lookup table. Readers will appreciate that determining 602 that the other power utilization metric exceeds the third threshold may also be performed before or independent of any querying of the memory lookup table. In some embodiments, the third threshold may include a predefined threshold. In some embodiments, the third threshold may be dynamically calculated based on a current output confidence for a current layer of the neural network processing the other one or more inputs. For example, in some embodiments, as the output confidence increases, the third threshold may decrease such that lower power utilization thresholds are required for higher output confidences while higher power utilization thresholds are required for lower output confidences.

The method of FIG. 6 also includes: responsive to the other power utilization metric exceeding the third threshold, providing 604 an intermediary output of the neural network instead of processing the other one or more inputs through all layers of the neural network. The intermediary output may include an output at a current layer other neural network when it was determined that the third threshold was exceeded. Thus, processing of the other one or more inputs may be overridden where power utilization exceeds the third threshold.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving one or more inputs for a neural network;
monitoring a power utilization metric during processing of the one or more inputs by the neural network;
determining, responsive to the power utilization metric exceeding a first threshold, whether an output confidence at a pre-output layer of the neural network exceeds a second threshold; and
storing, responsive to the output confidence exceeding the second threshold, an entry in a memory lookup table comprising an output of the neural network.

2. The method of claim 1, wherein the power utilization metric comprises an amount of power consumed.

3. The method of claim 1, wherein the power utilization metric comprises a number of activated neurons of the neural network.

4. The method of claim 1, wherein monitoring the power utilization metric comprises estimating an amount of power consumed based on a number of activated neurons of the neural network.

5. The method of claim 1, wherein the entry further comprises an activation map signature.

6. The method of claim 1, further comprising determining whether to store the entry in the memory lookup table based on a comparison between the output confidence at the pre-output layer of the neural network and another output confidence at an output layer of the neural network.

7. The method of claim 4, wherein determining whether to store the entry in the memory lookup table comprises comparing a difference between the other output confidence and the output confidence to a difference threshold.

8. The method of claim 1, further comprising:
receiving another one or more inputs for the neural network;
determining, during processing of the other one or more inputs by the neural network, whether an entry matching an activation map signature for processing the other one or more inputs is stored in the memory lookup table; and
responsive to the entry being stored in the memory lookup table, providing a stored output of the entry instead of processing the other one or more inputs through all layers of the neural network.

9. The method of claim 8, further comprising:
determining, during processing of the other one or more inputs by the neural network, that another power utilization metric exceeds a third threshold; and
responsive to the other power utilization metric exceeding the third threshold, providing an intermediary output of the neural network instead of processing the other one or more inputs through all layers of the neural network.

10. An apparatus comprising:
a processing device; and
memory operatively coupled to the processing device, wherein the memory stores computer program instructions that, when executed, cause the processing device to:
receive one or more inputs for a neural network;
monitor a power utilization metric during processing of the one or more inputs by the neural network;
determine, responsive to the power utilization metric exceeding a first threshold, whether an output confidence at a pre-output layer of the neural network exceeds a second threshold; and
store, responsive to the output confidence exceeding the second threshold, an entry in a memory lookup table comprising an output of the neural network.

11. The apparatus of claim 10, wherein the power utilization metric comprises an amount of power consumed.

12. The apparatus of claim 10, wherein the power utilization metric comprises a number of activated neurons of the neural network.

13. The apparatus of claim 10, wherein, to monitor the power utilization metric, the instructions, when executed, further cause the processing device to estimate an amount of power consumed based on a number of activated neurons of the neural network.

14. The apparatus of claim 10, wherein the entry further comprises an activation map signature.

15. The apparatus of claim 10, wherein the instructions, when executed, further cause the processing device to determine whether to store the entry in the memory lookup table based on a comparison between the output confidence at the pre-output layer of the neural network and another output confidence at an output layer of the neural network.

16. The apparatus of claim 15, wherein, to determine whether to store the entry in the memory lookup table, the instructions, when executed, further cause the processing device to compare a difference between the other output confidence and the output confidence to a difference threshold.

17. The apparatus of claim 10, wherein the instructions, when executed, further cause the processing device to:
receive another one or more inputs for the neural network;
determine, during processing of the other one or more inputs by the neural network, whether an entry matching an activation map signature for processing the other one or more inputs is stored in the memory lookup table; and
responsive to the entry being stored in the memory lookup table, provide a stored output of the entry instead of processing the other one or more inputs through all layers of the neural network.

18. The apparatus of claim 17, wherein the instructions, when executed, further cause the processing device to:
determine, during processing of the other one or more inputs by the neural network, that another power utilization metric exceeds a third threshold; and
responsive to the other power utilization metric exceeding the third threshold, provide an intermediary output of the neural network instead of processing the other one or more inputs through all layers of the neural network.

19. A computer program product comprising a computer readable storage medium, wherein the computer readable storage medium comprises computer program instructions that, when executed:
receive one or more inputs for a neural network;
monitor a power utilization metric during processing of the one or more inputs by the neural network;
determine, responsive to the power utilization metric exceeding a first threshold, whether an output confidence at a pre-output layer of the neural network exceeds a second threshold; and
store, responsive to the output confidence exceeding the second threshold, an entry in a memory lookup table comprising an output of the neural network.

20. The computer program product of claim 19, wherein the power utilization metric comprises an amount of power consumed.

21. The computer program product of claim 19, wherein the power utilization metric comprises a number of activated neurons of the neural network.

22. The computer program product of claim 19, wherein, to monitor the power utilization metric, the instructions, when executed, estimate an amount of power consumed based on a number of activated neurons of the neural network.

23. The computer program product of claim 19, wherein the entry further comprises an activation map signature.

24. The computer program product of claim 19, wherein the instructions, when executed, further determine whether to store the entry in the memory lookup table based on a comparison between the output confidence at the pre-output layer of the neural network and another output confidence at an output layer of the neural network.

25. The computer program product of claim 24, wherein, to determine whether to store the entry in the memory lookup table, the instructions, when executed, compare a difference between the other output confidence and the output confidence to a difference threshold.
